(19) United States
(12) Patent Application Publication
(10) Pub. No.: US 2024/0334357 A1
(43) Pub. Date: Oct. 3, 2024

(54) MULTIPLE TIMING ADVANCE GROUPS FOR MULTI-TRANSMISSION/RECEPTION POINT

(71) Applicant: Samsung Electronics Co., Ltd., Suwon-si (KR)

(72) Inventors: Shiyang Leng, Allen, TX (US); Anil Agiwal, Allen, TX (US)

(21) Appl. No.: 18/612,956

(22) Filed: Mar. 21, 2024

Related U.S. Application Data
(60) Provisional application No. 63/454,873, filed on Mar. 27, 2023.
(60) Provisional application No. 63/525,324, filed on Jul. 6, 2023.
(60) Provisional application No. 63/531,494, filed on Aug. 8, 2023.
(60) Provisional application No. 63/539,953, filed on Sep. 22, 2023.
(60) Provisional application No. 63/542,892, filed on Oct. 6, 2023.
(60) Provisional application No. 63/553,529, filed on Feb. 14, 2024.

(51) Int. Cl. H04W 56/00; H04L 1/1812; H04L 5/00; H04W 74/0833; H04W 76/20; H04W 80/02

(52) U.S. Cl. CPC H04W 56/0045; H04L 1/1812; H04L 5/0053; H04W 74/0833; H04W 76/20; H04W 80/02

(57) ABSTRACT

Methods and apparatuses for a multiple timing advance groups for a multi-TRP operation in a wireless communication system. A method of a UE comprises: determining whether a serving cell is configured with more than one TAG and a timer of a TAG associated with a TCI state stops or expires for a first HARQ feedback in a first HARQ process on the serving cell or a second HARQ feedback in a second HARQ process on the serving cell; determining to not generate a first indication indicating a lower layer to generate an ACK corresponding to a data transmission in a TB in the first HARQ process; and determining to not generate a second indication indicating the lower layer to generate an ACK corresponding to a data transmission in a TB in the second HARQ process when the serving cell is configured with a sl-PUCCH-Config.

### CROSS-REFERENCE TO RELATED APPLICATIONS AND CLAIM OF PRIORITY

The present application claims priority to:
U.S. Provisional Patent Application No. 63/454,873, filed on Mar. 27, 2023;
U.S. Provisional Patent Application No. 63/525,324, filed on Jul. 6, 2023;
U.S. Provisional Patent Application No. 63/531,494, filed on Aug. 8, 2023;
U.S. Provisional Patent Application No. 63/539,953, filed on Sep. 22, 2023;
U.S. Provisional Patent Application No. 63/542,892, filed on Oct. 6, 2023; and
U.S. Provisional Patent Application No. 63/553,529, filed on Feb. 14, 2024. The contents of the above-identified patent documents are incorporated herein by reference.

### TECHNICAL FIELD

The present disclosure relates generally to wireless communication systems and, more specifically, the present disclosure relates to multiple timing advance groups for a multi-transmission/reception point (TRP) communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to multiple timing advance groups for multiple TRPs in a wireless communication system.

In one embodiment, a user equipment (UE) in a wireless communication system is provided. The UE comprises a transceiver. The UE further comprises a processor operably coupled to the transceiver, the processor configured to: determine whether a serving cell is configured with more than one timing advance group (TAG) and a timer of a TAG associated with a transmission configuration indication (TCI) state stops or expires for (i) a transmission of a first hybrid automatic repeat request (HARQ) feedback in a first HARQ process on the serving cell or (ii) a transmission of a second HARQ feedback in a second HARQ process on the serving cell, determine, based on a determination that the serving cell is configured with more than one TAG and the timer of the TAG associated with the TCI state for the transmission of the first HARQ feedback is stopped or expired, to not generate a first indication indicating a lower layer to generate an acknowledgement (ACK) corresponding to a data transmission in a transport block (TB) in the first HARQ process, and determine, based on a determination that the serving cell is configured with more than one TAG and the timer of the TAG associated with the TCI state for the transmission of the second HARQ feedback is stopped or expired, to not generate a second indication indicating the lower layer to generate an ACK corresponding to a data transmission in a TB in the second HARQ process when the serving cell is configured with a sidelink physical uplink control channel configuration (sl-PUCCH-Config).

In another embodiment, a method of a UE in a wireless communication system is provided. The method comprises: determining whether a serving cell is configured with more than one TAG and a timer of a TAG associated with a TCI state stops or expires for (i) a transmission of a first HARQ feedback in a first HARQ process on the serving cell or (ii) a transmission of a second HARQ feedback in a second HARQ process on the serving cell; determining, based on a determination that the serving cell is configured with more than one TAG and the timer of the TAG associated with the TCI state for the transmission of the first HARQ feedback is stopped or expired, to not generate a first indication indicating a lower layer to generate an ACK corresponding to a data transmission in a TB in the first HARQ process; and determining, based on a determination that the serving cell is configured with more than one TAG and the timer of the TAG associated with the TCI state for the transmission of the second HARQ feedback is stopped or expired, to not generate a second indication indicating the lower layer to generate an ACK corresponding to a data transmission in a TB in the second HARQ process when the serving cell is configured with a sl-PUCCH-Config.

In yet another embodiment, a base station (BS) in a wireless communication system is provided. The BS comprises a processor. The BS further comprises a transceiver operably coupled to the processor, the transceiver configured to receive, from a UE, a transmission of a first HARQ feedback in a first HARQ process or a transmission of a second HARQ feedback in a second HARQ process, the BS belonging to a serving cell, wherein: whether the serving cell is configured with more than one TAG and a timer of a TAG associated with a TCI state stops or expires for (i) the transmission of a first HARQ feedback in the first HARQ process on the serving cell is determined or (ii) the transmission of the second HARQ feedback in a second HARQ process on the serving cell is determined, based on a determination that the serving cell is configured with more than one TAG and the timer of the TAG associated with the TCI state for the transmission of the first HARQ feedback is stopped or expired, an ACK corresponding to a data transmission in a TB in the first HARQ process is not received, and based on a determination that the serving cell is configured with more than one TAG and the timer of the TAG associated with the TCI state for the transmission of the second HARQ feedback is stopped or expired, an ACK corresponding to a data transmission in a TB in the second HARQ process is not received when the serving cell is configured with a sl-PUCCH-Config.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIGS. 6 and 7 illustrate examples of enhanced TAC MAC CE according to embodiments of the present disclosure;

FIGS. 8 and 9 illustrate examples of absolute TAC MAC CE according to embodiments of the present disclosure;

FIGS. 10-12 illustrate examples of MAC RAR or fallbackRAR according to embodiments of the present disclosure;

FIGS. 13-15 illustrate examples of successRAR according to embodiments of the present disclosure;

FIG. 16 illustrates a flowchart of a UE method for initiating RA procedure for multi-TA in intra-/inter-cell beam mobility according to embodiments of the present disclosure;

FIG. 17 illustrates a flowchart of a UE method for a RA fallback procedure in RACH-less mobility according to embodiments of the present disclosure;

FIGS. 18 and 19 illustrate flowcharts of UE methods for a RA fallback procedure in RACH-less mobility with RA-fallback timer according to embodiments of the present disclosure; and

FIG. 20 illustrates a flowchart of a UE method for multiple timing advance groups for a multi-TRP communication system according to embodiments of the present disclosure.

### DETAILED DESCRIPTION

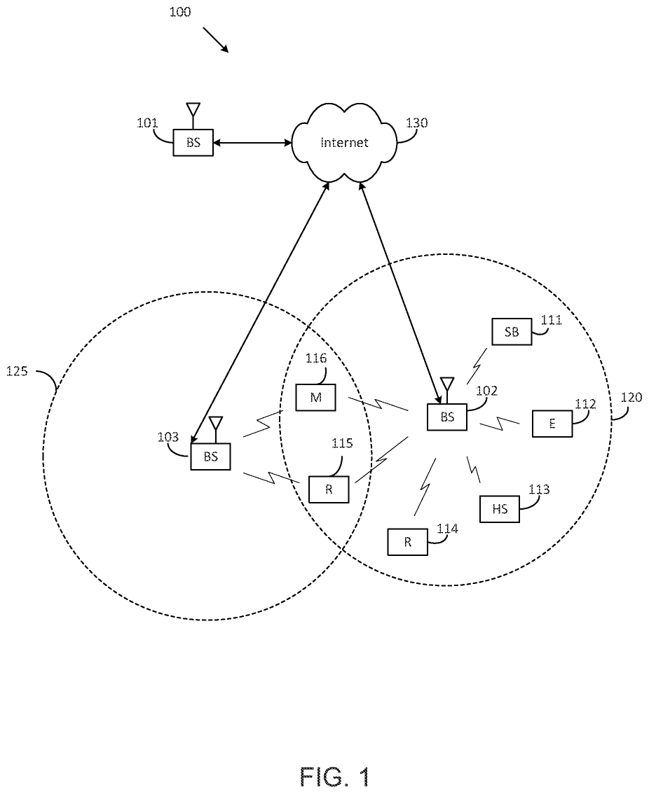

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: “3GPP, TS 38.300 v17.5.0, 5G; NR; NR and NG-RAN Overall Description; Stage 2”; “3GPP, TS 38.331 v17.5.0, 5G; NR; Radio Resource Control (RRC); Protocol specification”; and “3GPP, TS 38.321 v17.5.0, NR; Medium Access Control (MAC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for supporting multiple timing advance groups for a multi-TRP communication system. In certain embodiments, and one or more of the gNBs 101-103 includes circuitry, programing, or a combination thereof, for supporting multiple timing advance groups for a multi-TRP communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

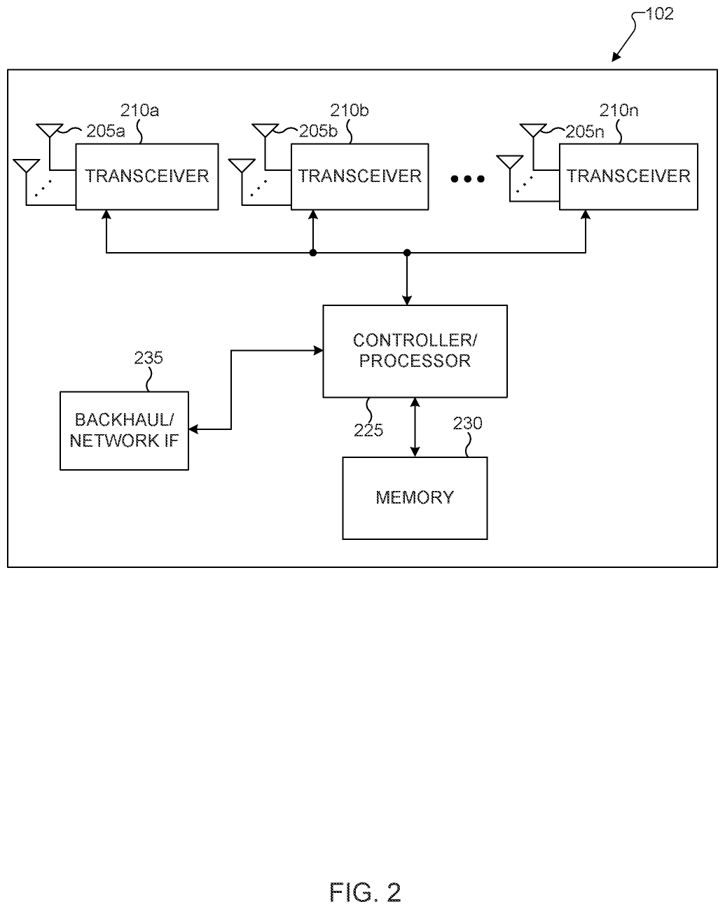

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes for supporting multiple timing advance groups for a multi-TRP communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

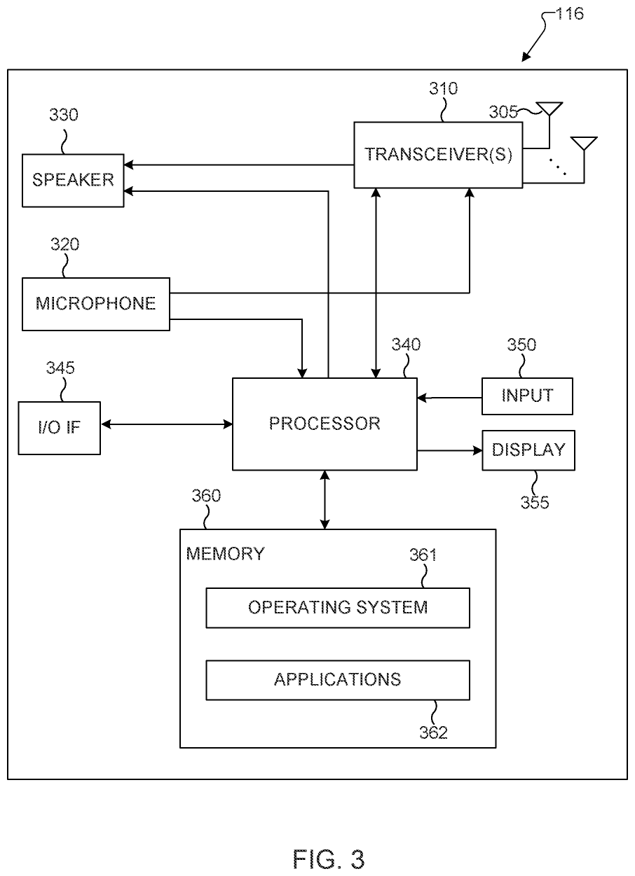

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for multiple timing advance groups for a multi-TRP communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

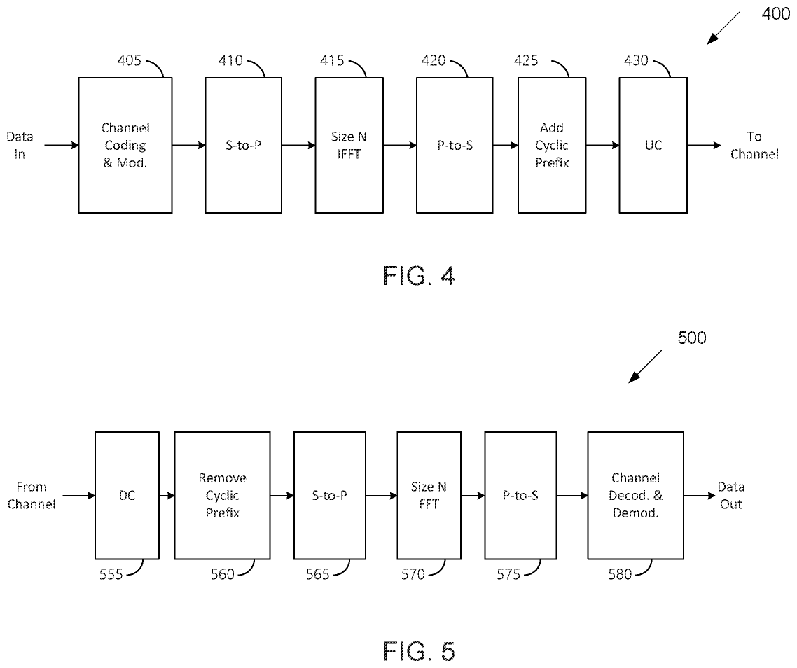

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support multiple timing advance groups for a multi-TRP communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

3GPP has developed technical specifications and standards to define the new 5G radio-access technology, known as 5G new radio (NR). Multiple-input multiple-output (MIMO) is one of the key technologies in NR systems and shows its success in commercial deployment. In multiple TRP (multi-TRP) operation, a serving cell can schedule the UE from two TRPs to provide better coverage, reliability and data rates for downlink and uplink transmission/receptions. Two operation modes are supported to schedule multi-TRP transmission: single-DCI for which the UE is scheduled by the same DCI for both TRPs and multi-DCI where the UE is scheduled by independent DCIs from each TRP.

In Rel-17, inter-cell multi-TRP operation is introduced, where one TRP is from the serving cell and the other TRP can from a cell with PCI other than the serving cell, i.e., a non-serving cell, without the change of serving cell. For downlink multi-DCI transmission, one or more TCI states can be associated with SSB from the non-serving cell. The activated TCI states can be associated with at most one non-serving cell at a time. For uplink transmission, the UE transmits the same contents towards two TRPs with corresponding beam directions associated with different spatial relations.

In Rel-17, a single timing advance (TA) is maintained for multi-TRP operation and inter-cell beam management, assuming the transmission from/to two TRPs are synchronized within cyclic prefix (CP). Although the serving cell is not changed through the inter-cell multi-TRP operation, the TRP(s) from the non-serving cell can be inter-DU (Distributed Unit) or intra-CU (Centralized Unit) which may have different propagation delay for UL transmission and may not be synchronized with the serving cell TRP. In another case, multiple TRPs from a serving cell may have different UL TAs. In such scenarios, two or multiple TAs are desired to be maintained by the UE for the serving cell and/or for the non-serving cell.

In Rel-17, an inter-cell multi-TRP operation is introduced, where one TRP is from the serving cell and the other TRP can from a cell with PCI other than the serving cell, i.e., a non-serving cell, without the change of serving cell. For downlink multi-DCI transmission, one or more TCI states can be associated with SSB from the non-serving cell. The activated TCI states can be associated with at most one non-serving cell at a time. For uplink transmission, the UE transmits the same contents towards two TRPs with corresponding beam directions associated with different spatial relations. For inter-cell and intra-cell multi-TRP operation, more than one TAGs can be configured for a serving cell.

In a HARQ process, a UE sends a HARQ feedback to inform the network whether a TB is successfully received or not. The UE handles HARQ feedback according to the TAT status of a timing advance group (TAG) for a serving cell.

For a multi-TRP operation with more than one TAs, more than one TAG can be configured for a serving cell. How to handle the HARQ feedback according to the TAT status of a TAG for a serving cell may be specified.

In the present disclosure, TA management is provided, where multiple TAs and the corresponding multiple timing advance groups (TAGs) are maintained for a serving cell and non-serving cells, for example, in multi-TRP operation, inter-cell beam management operation, and in early UL synchronization for L1/L2 triggered mobility. MAC procedures are specified. In this disclosure, operations for a second TRP from a serving cell can also be applied to a TRP or TCI state(s) from a non-serving cell, vice versa. In this disclosure, the non-serving cell can refer to an additional cell with PCI other than the serving cell or refer to a candidate cell configured for L1/L2 triggered mobility (LTM).

In the present disclosure, solutions to handle HARQ feedback are provided.

In one embodiment, serving cells and/or TRPs in a MAC entity (i.e., a cell groups) can be grouped where each group maintains a common TA and a common Time Alignment Timer (TAT). The timeAlignmentTimer (per TAG) controls how long the MAC entity considers the cells or TRPs belonging to the associated TAG to be uplink time aligned.

In one embodiment, the UE can report its capability of supporting N timing advance groups (TAGs) by an indication, where N can be 8 or 16. Based on UE's capability, the network can configure maximum N TAGs per MAC entity. The value of N can be reported by UE as a UE capability, and NW can configure a number of TAGs per MAC entity (i.e., per cell group) based on the reported UE capability, e.g., a number smaller or equal to N. For example, the parameter maxNrofTAGs can be 8 or 16 or 24 included in information element (IE) TAG-Config in MAC-CellGroupConfig.

In one embodiment, a timing advance command (TAC) can be sent in an Enhanced TAC MAC CE for UE to adjust TA for UL synchronization. The Enhanced TAC MAC CE can support more than 4 TAGs by extending the bits for TAG ID field. The Enhanced TAC MAC CE can be identified by MAC subheader with a LCID for DL-SCH or an eLCID for DL-SCH with one octet or two octets. It can have a fixed size or a variable size indicated by the Length field L in the MAC subheader. It can include a n-bit field of TAG ID indicating the TAG ID of the addressed TAG, where n can be an integer larger than 2, e.g., log 2 (N). The TAG containing the SpCell can have TAG ID 0 or 1 or an integer up to N.

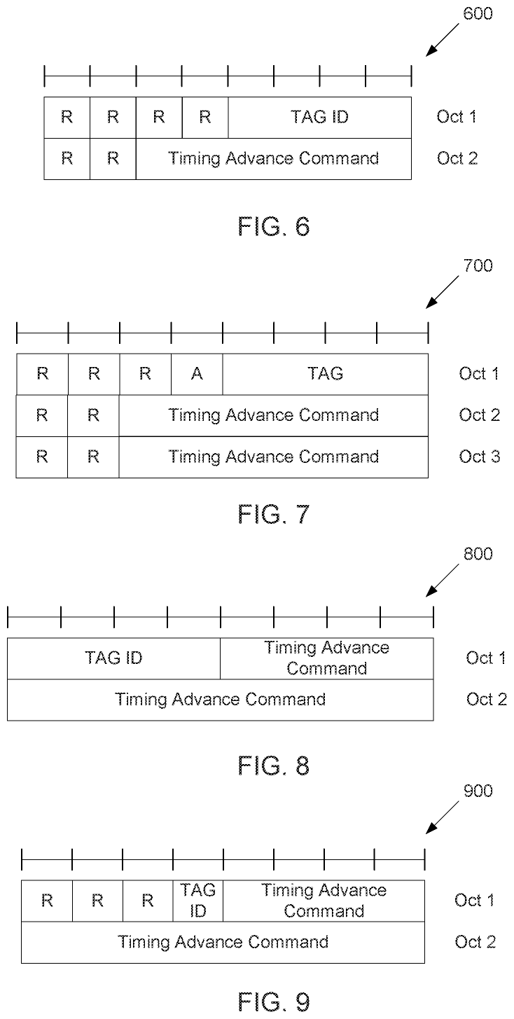

FIGS. 6 and 7 illustrate examples of enhanced TAC MAC CE 600 to 700 according to embodiments of the present disclosure. Embodiments of the enhanced TAC MAC CE 600 to 700 shown in FIGS. 6 and 7 are for illustration only.

An example of enhanced TAC MAC CE is illustrated in FIG. 6. The enhanced TAC MAC CE can have a field of TAC. This field indicates the index value TA (0, 1, 2 . . . 63) used to control the amount of timing adjustment that MAC entity may apply. The length of the field is 6 bits. The enhanced TAC MAC CE can be transmitted by the NW and be applied to adjust TA when more than 4 TAGs are configured for the MAC entity to which the enhanced TAC MAC CE is applied. Alternatively, the enhanced TAC MAC CE can be transmitted by the NW and be applied to adjust TA when at least one serving cell of the cell group associated with the MAC entity to be applied are configured with multiple TAG IDs.

As another example of enhanced TAC MAC CE, as illustrated in FIG. 7, a TAC field of 6 bits or 12 bits can be included. A one-bit field, e.g., field A, can indicate if the second octet including 6-bit TAC field (i.e., October 3) is present or not, i.e., field A set to 0 indicates the second octet for TAC (i.e., October 3) is absent and the 6-bit TAC field indicates the index value TA (0, 1, 2 . . . 63) used to control the amount of timing adjustment that MAC entity may apply; field A set to 1 indicates the second octet for TAC (i.e., October 3) is present and the 12-bit TAC field indicates the index value TA used to indicate the absolute TA value that the MAC entity may apply. The Enhanced TAC MAC CE can be transmitted by the NW and be applied when more than 4 TAGs are configured for the MAC entity to which the enhanced TAC MAC CE is applied. Alternatively, the Enhanced TAC MAC CE can be transmitted by the NW and be applied to adjust TA when at least one serving cell of the cell group associated with the MAC entity to be applied are configured with multiple TAG IDs.

In one embodiment, a timing advance command (TAC) can be sent in an absolute TAC MAC CE for UE to indicate the TA for UL transmission. In one example, the absolute TAC MAC CE can include an indication of TAG to which the MAC CE is applied. An example of absolute TAC MAC CE is illustrated in FIG. 8. The 4 reserved bits in the existing absolute TAC MAC CE can be used to indicate the TAG ID. The TAG ID field indicates the TAG ID of the addressed TAG. The TAG containing the SpCell can have TAG ID 0 or 1 or an integer up to N. The TAG ID field can be applied/present if more than 4 TAGs are configured for the MAC entity of PCell to which the absolute TAC MAC CE is applied, or if multiple TAG IDs are configured for the PCell/SpCell; otherwise (i.e., if the MAC entity of PCell/SpCell to which the absolute TAC MAC CE is applied is configured with no more than 4 TAGs or if the PCell/SpCell is configured with only one TAG ID), the UE ignores the TAG ID field.

FIGS. 8 and 9 illustrate examples of absolute TAC MAC CE 800 to 900 according to embodiments of the present disclosure. Embodiments of the absolute TAC MAC CE 800 to 900 shown in FIGS. 8 and 9 are for illustration only.

In another example, as illustrated in FIG. 9, the absolute TAC MAC CE can include an indication of one of the two TAGs configured for the MAC entity of PCell, to which the TAC is applied. One reserved bit in the existing absolute TAC MAC CE can be used to indicate one of the two TAGs configured for the MAC entity, i.e., TAG ID field set to 0 indicates the first TAG ID or the TAG ID with a smaller index value configured for the MAC entity of PCell, TAG ID field set to 1 indicates the second TAG ID or the TAG ID with a larger index value configured for the MAC entity of PCell. The TAG ID field can be applied/present if more than 4 TAGs are configured for the MAC entity of PCell/SpCell to which the absolute TAC MAC CE is applied, or if multiple TAG IDs are configured for the PCell/SpCell; otherwise (i.e., if the MAC entity of PCell/SpCell to which the absolute TAC MAC CE is applied is configured with no more than 4 TAGs or if the PCell/SpCell is configured with only one TAG ID), the UE ignores the TAG ID field.

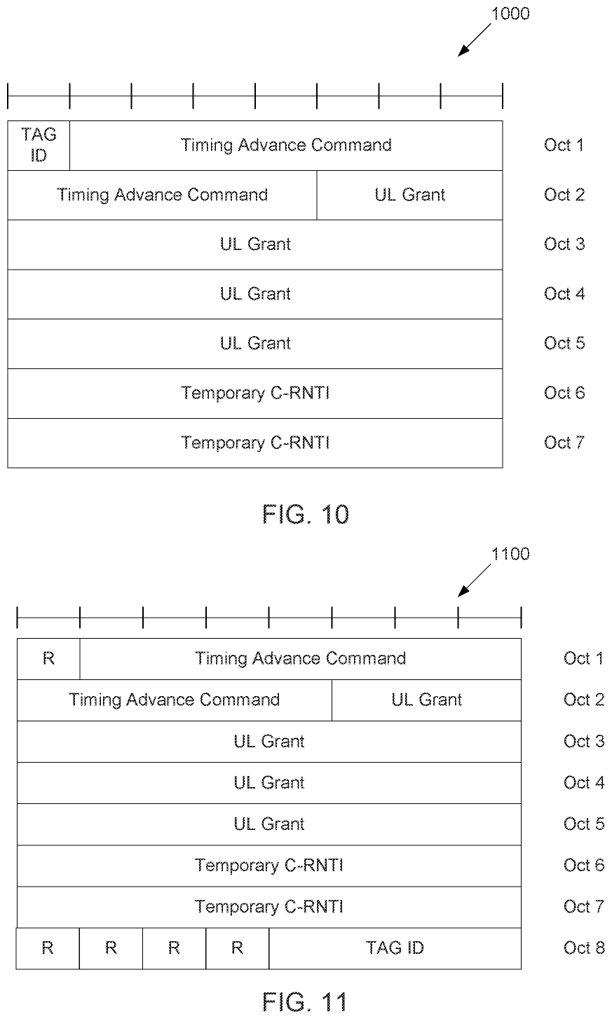

FIGS. 10 to 12 illustrate examples of MAC RAR or fallbackRAR 1000 to 1200 according to embodiments of the present disclosure. Embodiments of the MAC RAR or fallbackRAR 1000 to 1200 shown in FIGS. 10 to 12 are for illustration only.

In one embodiment, the MAC random access response (RAR) and/or fallback RAR and/or successRAR can include an indication of TAG to which the TAC is applied. An example of MAC RAR and fallbackRAR is illustrated in FIG. 10.

FIGS. 13 to 15 illustrate examples of successRAR 1300 to 1500 according to embodiments of the present disclosure. Embodiments of the successRAR 1300 to 1500 shown in FIGS. 13 to 15 are for illustration only.

An example of successRAR is illustrated in FIG. 13. The MAC RAR and/or fallback RAR and/or successRAR includes an indication of one of the two TAGs configured for the MAC entity, to which the TAC in RAR is applied. The reserved bit in the existing MAC RAR and/or fallback RAR and/or successRAR can be used to indicate one of the two TAGs configured for the serving cell, i.e., TAG ID (or TAG Index) field set to 0 indicates the first TAG ID or the TAG ID with a smaller index value configured for the serving cell, TAG ID field set to 1 indicates the second TAG ID or the TAG ID with a larger index value configured for the serving cell. The TAG ID field can be applied if two TAGs are configured for the serving cell to which the MAC RAR and/or fallback RAR and/or successRAR is applied; otherwise (i.e., if the serving cell to which the MAC RAR and/or fallback RAR and/or successRAR is applied is configured with only one TAG), the UE ignores the TAG ID field.

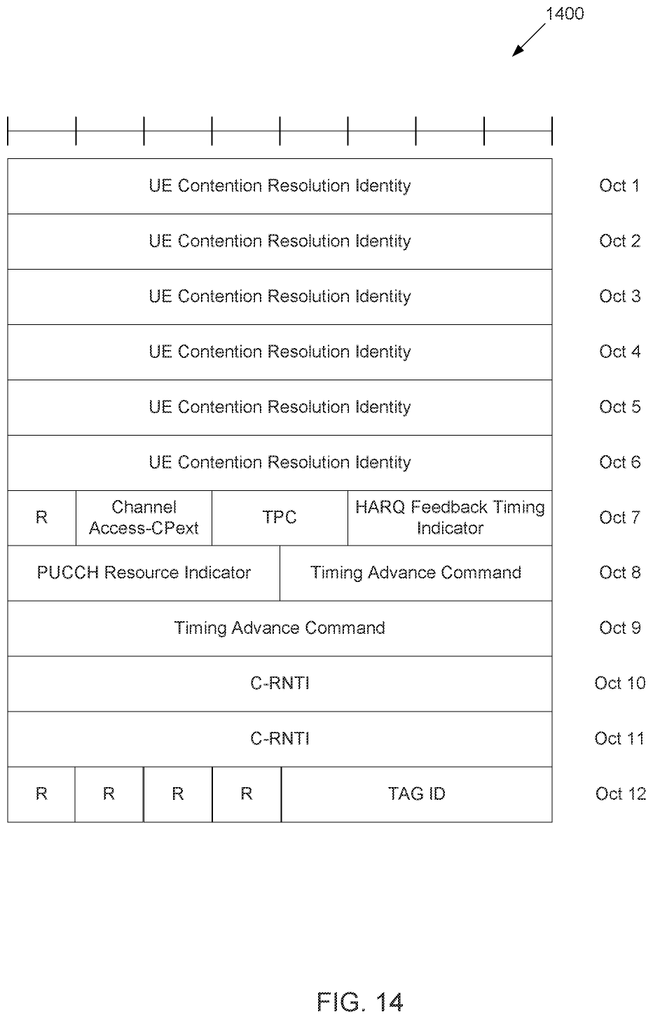

In another example of MAC RAR and/or fallback RAR is illustrated in FIG. 11, where a TAG ID field is included to indicate the TAG ID to which the TAC is applied. Similarly, a TAG ID field can be included in successRAR in response to MSGB in 2-step random access, as illustrated in FIG. 14. The MAC RAR and/or fallback RAR and/or successRAR with TAG indication can be transmitted by the NW and applied when multiple TAG IDs are configured for the serving cell and/or when more than 4 TAGs are configured for the MAC entity of the serving cell to which the MAC RAR and/or fallback RAR and/or successRAR is intended. The TAG ID field can be applied if multiple TAG IDs are configured for the serving cell to which the MAC RAR is applied or if more than 4 TAGs are configured for the MAC entity of the serving cell to which the MAC RAR and/or fallback RAR and/or successRAR is applied; otherwise (i.e., if the MAC entity of the serving cell to which the MAC RAR and/or fallback RAR and/or successRAR is applied is configured with no more than 4 TAGs or if only one TAG ID is configured for the serving cell to which the MAC RAR and/or fallback RAR and/or successRAR is applied), the UE ignores the TAG ID field.

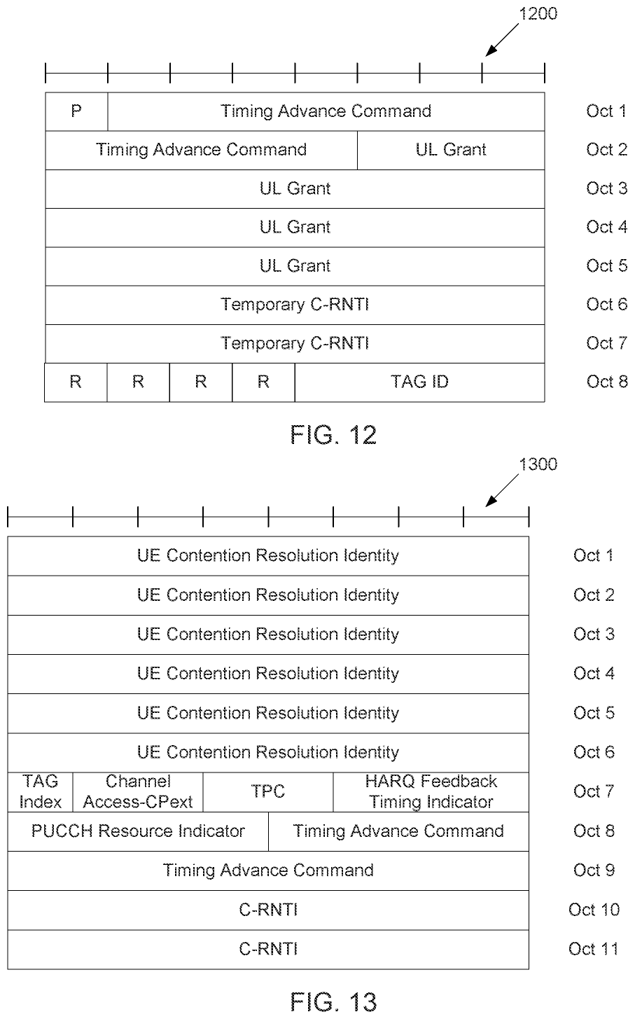

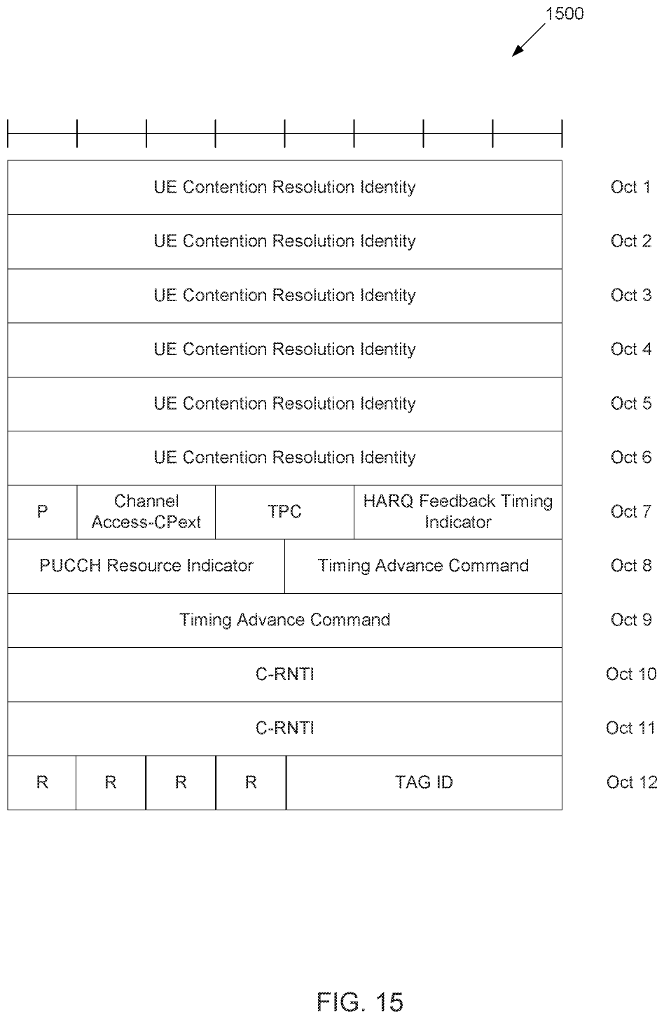

In one example of MAC RAR and/or fallback RAR is illustrated in FIG. 12. A TAG ID field is included to indicate the TAG ID to which the TAC is applied and the reserved bit is used to indicate whether the TAG ID field is present, i.e., P field set to 0 indicates the octet containing the TAG ID field is absent, P field set to 1 indicates the octet containing the TAG ID field is present. Similarly, in the successRAR in response to MSGB in 2-step Random Access, a TAG ID field with the reserved bit reused as an indicator of the presence of the TAG ID field, i.e., field P, can be included, as illustrated in FIG. 15. The MAC RAR and/or fallback RAR and/or successRAR with TAG indication can be transmitted by the NW and applied when two TAG IDs are configured for the serving cell to which the MAC RAR and/or fallback RAR and/or successRAR is intended and/or when more than 4 TAGs are configured for the MAC entity of the serving cell to which the MAC RAR and/or fallback RAR and/or successRAR is intended.

To maintain UL time alignment for multi-TRP operation, one timeAlignmentTimer can be configured per TAG which controls how long the MAC entity considers the TRPs belonging to the associated TAG to be uplink time aligned.

As an example, for a MAC entity, when an Enhanced Timing Advance Command MAC CE is received, and if an NTA (as defined in TS 38.211) has been maintained with the indicated TAG, the MAC entity applies the Timing Advance Command for the indicated TAG, and/or starts or restarts the timeAlignmentTimer associated with the indicated TAG.

For example, when a TAC is received in a RAR message for a serving cell or for a TRP belonging to a TAG, if the timeAlignmentTimer associated with this TAG is not running, the MAC entity applies the TAC for this TAG, and/or starts the timeAlignmentTimer associated with this TAG; alternatively, when a TAC is received in a RAR message with an indicated TAG, if the timeAlignmentTimer associated with this TAG is not running, the MAC entity applies the TAC for this TAG, and/or starts the timeAlignmentTimer associated with this TAG.

In one example, in the following cases, a UE applies the TAC in RAR.

When a timing advance command is received in a random access response message for a serving cell belonging to a TAG or in a MSGB for an SpCell if only one TAG is configured for the cell; or when a timing advance Command is received in a random access response message or in a MSGB with an indication of the TAG to be applied; or when a timing advance command is received in a random access response message or in a MSGB in response to a random access preamble that is transmitted in a PRACH occasion corresponding to a selected SSB for which a TAG is configured to be associated with; or when a timing advance command is received in a random access response message for a serving cell or in a MSGB for an SpCell, and for the TAG configured with a specific ID (e.g., tag-Id, the TAG ID with the smallest value among all configured TAG IDs, the first TAG, the TAG with ID 0) for this cell.

A UE applies the timing advance command for this TAG and start or restart the timeAlignmentTimer associated with this TAG, if the random access preamble was not selected by the MAC entity among the contention-based random access preamble; else if the timeAlignmentTimer associated with this TAG is not running, UE applies the timing advance command for this TAG and start the timeAlignmentTimer associated with this TAG.

For another example, when an absolute TAC MAC CE is received in response to a MSGA transmission including C-RNTI MAC CE, and if multiple TAGs are configured for the SpCell or if at least one serving cell of the cell group of the MAC entity is configured with multiple TAG IDs, the MAC entity applies the TAC for the indicated primary timing advance group (PTAG) for the SpCell, and/or starts or restarts the timeAlignmentTimer associated with PTAG.

As more example, in the following cases, a UE applies the TAC in the absolute TAC MAC CE.

When an absolute timing advance command is received in response to a MSGA transmission including C-RNTI MAC CE as specified in 3GPP specification, and for the PTAG of the SpCell if only one TAG is configured for the SpCell; or when an absolute timing advance command is received in response to a MSGA transmission including C-RNTI MAC CE as specified in 3GPP standard specification, and for the PTAG indicated in the absolute TAC MAC CE; or when an absolute timing advance command is received in response to a MSGA transmission including C-RNTI MAC CE as specified in 3GPP standard specification and the MSGA preamble is transmitted in a PRACH occasion corresponding to a selected SSB for which a PTAG is configured to be associated with; or when an absolute timing advance command is received in response to a MSGA transmission including C-RNTI MAC CE as specified in 3GPP standard specification, and for the PTAG configured with a specific ID (e.g., tag-Id, the TAG ID with the smallest value among all configured TAG IDs, the first TAG, the TAG with ID 0) for this SpCell: a UE applies the TAC for the PTAG.

In yet another example, upon the UE receiving the RRCSetup message in response to an RRCReestablishmentRequest message or an RRCResumeRequest message or an RRCResumeRequest1 message, or upon the UE receiving the RRCResume message, if sdt-MAC-PHY-CG-Config is configured, the UE instructs the MAC entity to stop the cg-SDT-TimeAlignmentTimer if it is running, and instructs the MAC entity to start one timeAlignmentTimer associated with one specific PTAG or the PTAG with the smaller (or smallest) value of TAG ID if two (multiple) TAGs are configured for the SpCell and if the timeAlignmentTimer for none PTAG is running. When instruction from the upper layer has been received for starting the TimeAlignmentTimer associated with a PTAG, the MAC entity starts the TimeAlignmentTimer associated with the indicated PTAG or the PTAG with the smaller (or smallest) value of TAG ID if two (or multiple) TAG IDs are configured for the MAC entity of the SpCell.

In yet another example, if multiple TAGs are configured for the SpCell, when the timeAlignmentTimers associated with all PTAGs have expired, the MAC entity can flush all HARQ buffers for all serving cells; and/or notify RRC to release PUCCH for all serving cells, if configured; and/or notify RRC to release sounding reference signal (SRS) for all cells, if configured; and/or clear any configured downlink assignments and configured uplink grants; and/or clear any PUSCH resource for semi-persistent CSI reporting; and/or consider all running timeAlignmentTimers as expired; and/or maintain NTA (defined in TS 38.21) of all TAGs. If multiple TAGs are configured for the SpCell, when only the timeAlignmentTimer associated with one PTAG expires, the MAC entity can suspend any UL transmission except the random access preamble to the TRP associated with the PTAG for which the timeAlignmentTimer has expired.\

In yet another example, if multiple TAGs are configured for the cell with or without sl-PUCCH-Config configured, and if the timeAlignmentTimer, associated with the TAG containing one TRP of the cell on which the HARQ feedback is to be transmitted, is stopped or expired, the MAC entity does not instruct the physical layer to generate acknowledgement(s) of the data in this TB using an activated TCI state that is associated with the TAG of this timeAlignmentTimer or to this TRP. Alternatively, if multiple TAGs are configured for the cell with or without sl-PUCCH-Config configured, and if the timeAlignmentTimers, associated with all TAGS for the cell on which the HARQ feedback is to be transmitted, is stopped or expired, the MAC entity does not instruct the physical layer to generate acknowledgement(s) of the data in this TB.

In another example, if a SCG is configured as activated by upper layers, and if the timeAlignmentTimer associated with the PTAG is not running when only one TAG is configured for the SpCell or if the timeAlignmentTimer associated with none PTAG is running when multiple TAGs are configured for the SpCell, the MAC entity of the configured SCG indicates to upper layers that a random access procedure is needed for SCG activation.

In one embodiment, a TAG associated with a SpCell is PTAG, and there is only one PTAG per cell group. In one example, only one TAG is configured for the SpCell and the TAG is PTAG. In another example, multiple TAGs are configured for the SpCell and only one of them is configured/defined as PTAG, and the other TAGs are configured/defined as secondary timing advance group (STAG). As an example, a UE can perform the following procedure when the Time alignment timer (TAT) for a TAG expires.

The MAC entity may not perform any uplink transmission on a serving cell except the random access preamble and MSGA transmission when the timeAlignmentTimer associated with the TAG to which this Cell belongs is not running if only one TAG is configured for the serving cell, a configured grant-small data transmission (CG-SDT) procedure is not ongoing and SRS transmission in RRC_INACTIVE as in 3GPP standard specification is not on-going.

The MAC entity may not perform any uplink transmission except the random access preamble and MSGA transmission on a serving cell using a TCI state associated with a TAG for which the timeAlignmentTimer is not running as shown below in TABLE 1.

TABLE 1
MAC entity operation

| | |
|---|---|
| 1> | when a timeAlignmentTimer expires: |
| 2> | if the timeAlignmentTimer is associated with the PTAG: |
| 3> | flush all HARQ buffers for all cells; |
| 3> | notify RRC to release PUCCH for all cells, if configured; |
| 3> | notify RRC to release SRS for all cells, if configured; |
| 3> | clear any configured downlink assignments and configured uplink grants; |
| 3> | clear any PUSCH resource for semi-persistent CSI reporting; |
| 3> | consider all running timeAlignmentTimers as expired; |
| 3> | maintain N_{TA} (defined in TS 38.211) of all TAGs. |
| 2> | else if the timeAlignmentTimer is associated with an STAG, then for all serving |

cells belonging to this TAG and configured with only one STAG; or
2> if the timeAlignmentTimer is associated with an STAG, then for all cells configured with
this TAG and also other STAG(s), and if the timeAlignmentTimer(s) of all other STAG(s) are
expired:

| | |
|---|---|
| 3> | flush all HARQ buffers; |
| 3> | notify RRC to release PUCCH, if configured; |
| 3> | notify RRC to release SRS, if configured; |
| 3> | clear any configured downlink assignments and configured uplink grants; |
| 3> | clear any PUSCH resource for semi-persistent CSI reporting; |
| 3> | maintain N_{TA} (defined in TS 38.211) of this TAG. |

```
    2> else if the timeAlignmentTimer is associated with an STAG, then for all cells configured
with this TAG and configured with other TAG(s), and if the timeAlignmentTimer(s) of at least
one of the other TAG(s) is running;
        3> notify RRC to release PUCCH that is configured to be used only with TCI states
associated with this TAG, if configured; and/or
```

| | |
|---|---|
| 3> | notify RRC to release SRS that is configured to be used only with TCI states |

associated with this TAG, if configured; and/or

| | |
|---|---|
| 3> | clear any configured downlink assignments and configured uplink grants that are |

configured to be used only with TCI states associated with this TAG; and/or

| | |
|---|---|
| 3> | clear any PUSCH resource for semi-persistent CSI reporting that are configured |

to be used only with TCI states associated with this TAG; and/or
3> maintain N_{TA} (defined in TS 38.211) of this TAG.

In one embodiment, a TAG associated with a SpCell is PTAG, and there are more than one PTAG per a cell group. In one example, multiple TAGs are configured for the SpCell and more than one of them or all of them are configured/defined as PTAGs. As an example, a UE can perform the following procedure when the time alignment timer (TAT) for a TAG expires.

The MAC entity may not perform any uplink transmission on a serving cell except the random access preamble and MSGA transmission when the timeAlignmentTimer associated with the TAG to which this serving cell belongs is not running if only one TAG is configured for the serving cell, CG-SDT procedure is not ongoing and SRS transmission in RRC_INACTIVE as in 3GPP standard specification is not on-going.

The MAC entity may not perform any uplink transmission except the random access preamble and MSGA transmission on a serving cell using a TCI state associated with a TAG for which the timeAlignmentTimer is not running.

Furthermore, when the timeAlignmentTimer associated with the PTAG is not running if only one PTAG is configured for the SpCell, the timeAlignmentTimer associated with all PTAGs are not running if more than one PTAG is configured for the SpCell, CG-SDT procedure is not ongoing and SRS transmission in RRC_INACTIVE as in 3GPP standard specification is not ongoing, the MAC entity may not perform any uplink transmission on any serving cell except the random access preamble and MSGA transmission on the SpCell. TABLE 2 shows the MAC entity operation.

TABLE 2
MAC entity operation

| | |
|---|---|
| 1> | when a timeAlignmentTimer expires: |
| 2> | if the timeAlignmentTimer is associated with the PTAG and there is only one |

PTAG; or
2> if the timeAlignmentTimer is associated with a PTAG and the timeAlignmentTimer(s)
associated with all the other PTAG(s), if configured, are expired:

| | |
|---|---|
| 3> | flush all HARQ buffers for all cells; |
| 3> | notify RRC to release PUCCH for all cells, if configured; |
| 3> | notify RRC to release SRS for all cells, if configured; |
| 3> | clear any configured downlink assignments and configured uplink grants; |
| 3> | clear any PUSCH resource for semi-persistent CSI reporting; |
| 3> | consider all running timeAlignmentTimers as expired; |
| 3> | maintain N_{TA} (defined in TS 38.211) of all TAGs. |
| 2> | else if the timeAlignmentTimer is associated with an STAG, then for all cells |

belonging to this TAG and configured with only one STAG; or
2> if the timeAlignmentTimer is associated with a TAG, then for all cells configured with
this TAG and also other TAG(s), and the timeAlignmentTimer(s) of all other TAG(s) are expired:

| | |
|---|---|
| 3> | flush all HARQ buffers; |
| 3> | notify RRC to release PUCCH, if configured; |
| 3> | notify RRC to release SRS, if configured; |
| 3> | clear any configured downlink assignments and configured uplink grants; |
| 3> | clear any PUSCH resource for semi-persistent CSI reporting; |
| 3> | maintain N_{TA} (defined in TS 38.211) of this TAG. |

```
    2> else if the timeAlignmentTimer is associated with a TAG, then for all serving cells
configured with this TAG and also configured with other TAG(s), and the
timeAlignmentTimer(s) of at least one of the other TAG(s) is running;
        3> notify RRC to release PUCCH that is configured to be use only with TCI states
associated with this TAG, if configured; and/or
```

| | |
|---|---|
| 3> | notify RRC to release SRS that is configured to be used only with TCI states |

associated with this TAG, if configured; and/or

| | |
|---|---|
| 3> | clear any configured downlink assignments and configured uplink grants that are |

configured to be used only with TCI states associated with this TAG; and/or

| | |
|---|---|
| 3> | clear any PUSCH resource for semi-persistent CSI reporting that are configured |

to be used only with TCI states associated with this TAG; and/or
3> maintain N_{TA} (defined in TS 38.211) of this TAG.

An UL resource and/or an UL resource set (e.g., for PUCCH/PUSCH/SRS) and/or a DL assignment can be configured/indicated to associate with a TRP and/or TAG and/or TCI states and/or coreset pool index by RRC/MAC/PHY signaling (e.g., via RRC parameters, MAC CE, DCI fields).

In one example, to identify the resources for PUCCH and/or SRS and/or PUSCH and/or configured downlink assignments and/or configured uplink grants that are configured to be used/scheduled only with TCI states associated a specific TAG, if an UL resource (for PUCCH/PUSCH/SRS) and/or a DL assignment is configured/indicated to associated with a set of TCI state IDs, and the corresponding TCI states are all associated to a coreset pool index (e.g., according to indications in the TCI state activation/deactivation MAC CE), and all associated with one TAG (e.g., according to configuration by RRC signaling), a UE considers this UL resource and/or DL assignment can only be used/scheduled with TCI states associated with that TAG. If the timeAlignmentTimer for that TAG expires, the UE releases/clears the UL resource and/or DL assignment.

3GPP has developed technical specifications and standards to define the new 5G radio-access technology, known as 5G NR. Mobility handling is a critical aspect in any mobile communication system including 5G system. For a UE in connected mode, mobility is controlled by the network with the assistance from the UE to maintain a good quality of connection. Based on the measurement on radio link quality of the serving cell and neighboring cell(s) reported by the UE, the network may hand over the UE to a neighboring cell that can provide better radio conditions when the UE is experiencing a degraded connection to the serving cell.

Network controlled mobility applies to UEs in an RRC_CONNECTED and is categorized into two types of mobility: cell level mobility and beam level mobility. Cell level mobility requires explicit RRC signalling to be triggered, i.e., handover. The source BS/cell provides the RRC configuration to the UE by forwarding the RRCReconfiguration message from the target BS/cell. The RRCReconfiguration message includes at least cell ID and all information required to access the target cell so that the UE can access the target cell without reading system information. For some cases, the information required for contention-based and contention-free random access can be included in the RRCReconfiguration message. The access information to the target cell may include beam specific information, if any. The UE moves the RRC connection to the target BS/cell and replies with the RRCReconfigurationComplete.

Beam level mobility does not require explicit RRC signalling to be triggered. Beam level mobility includes intra-cell beam level mobility and inter-cell beam level mobility. The latter is referred to as inter-cell beam management (ICBM). For ICBM, a UE can receive or transmit UE dedicated channels/signals via a TRP associated with a PCI different from the PCI of a serving cell, while non-UE-dedicated channels/signals can only be received via a TRP associated with a PCI of the serving cell. The BS provides via RRC signalling the UE with measurement configuration containing configurations of SSB/CSI resources and resource sets, reports and trigger states for triggering channel and interference measurements and reports.

In case of ICBM, a measurement configuration includes SSB resources associated with PCIs different from the PCI of a serving cell. Beam level mobility is then dealt with at lower layers by means of physical layer and MAC layer control signalling, and RRC is not required to know which beam is being used at a given point in time. SSB-based beam level mobility is based on the SSB associated to the initial DL BWP and can only be configured for the initial DL BWPs and for DL BWPs containing the SSB associated to the initial DL BWP. For other DL BWPs, beam level mobility can only be performed based on CSI-RS.

When accessing or switching to the target cell/TRP, a UE may acquire the timing advance (TA) for UL transmissions to the target cell/TRP. Here accessing or switching the target cell/TRP can refer to applying a beam associated to the target cell/TRP for UL transmissions. Multiple mechanisms are supported for TA acquisition. The default procedure is that UE initiates RACH to the target cell when receiving a cell switch command.

Early TA acquisition procedure is supported in a way that NW requests RACH to a candidate cell or to an intra-/inter-cell TRP. The RACH is ordered by PDCCH, which can include candidate cell ID, and/or SSB index, and/or preamble index, and/or PRACH occasion, and/or first PRACH transmission or retransmission indication. Upon receiving the PDCCH order, a UE sends PRACH to the candidate cell using dedicated RACH resource for contention-free random access (CFRA), where the CFRA configuration is pre-configured. The UE can receive TAC in RAR for the intra-/inter-cell TRP, or the UE can receive TA of the candidate cell in cell switch command.

Apart from RACH-based RA acquisition, RACH-less TA acquisition is also supported. In one way, a UE can acquire TA of a candidate cell or to an intra-/inter-cell TRP by the UE estimation if the UE is capable of TA estimation. To estimate TA, the UE can measure reference signals from current serving cell and the candidate cell or the intra-/inter-cell TRP, the UE estimates TA based on serving cell's TA and the timing of measured RSs. In another way, the UE can acquire the TA of a candidate cell or to an intra-/inter-cell TRP by NW indication, the TA indication can be included in cell switch command or a TAC MAC CE.

In one example, a NW can provide beam indication for accessing the target cell/TRP in RRC message or MAC CE or L1 signaling. The beam indication can be the identifiers for one or more TCI states or indexes of Reference signals (e.g., SSB, CSI-RS). A joint TCI state can be indicated, or one DL TCI state and one UL TCI state can be indicated. The beam indication, e.g., joint TCI state or DL TCI state, can indicate the beam to be used to monitor the PDCCH providing the dynamic grant for the initial UL transmission for RACH-less HO. The beam indication, e.g., joint TCI state or UL TCI state, can indicate the beam to be used for the initial UL transmission for RACH-less HO, where the initial UL transmission can use either the configured grant if configured or the dynamic grant provided in PDDCH.

For RACH-based TA acquisition for mobility, an RA procedure needs to be enhanced for intra-/inter-cell beam mobility. For RACH-less mobility, an RA fallback procedure is desired to improve the mobility robustness.

In the present disclosure, the RA procedure is provided for intra-/inter-cell beam mobility and the RA fallback procedure for RACH-less mobility.

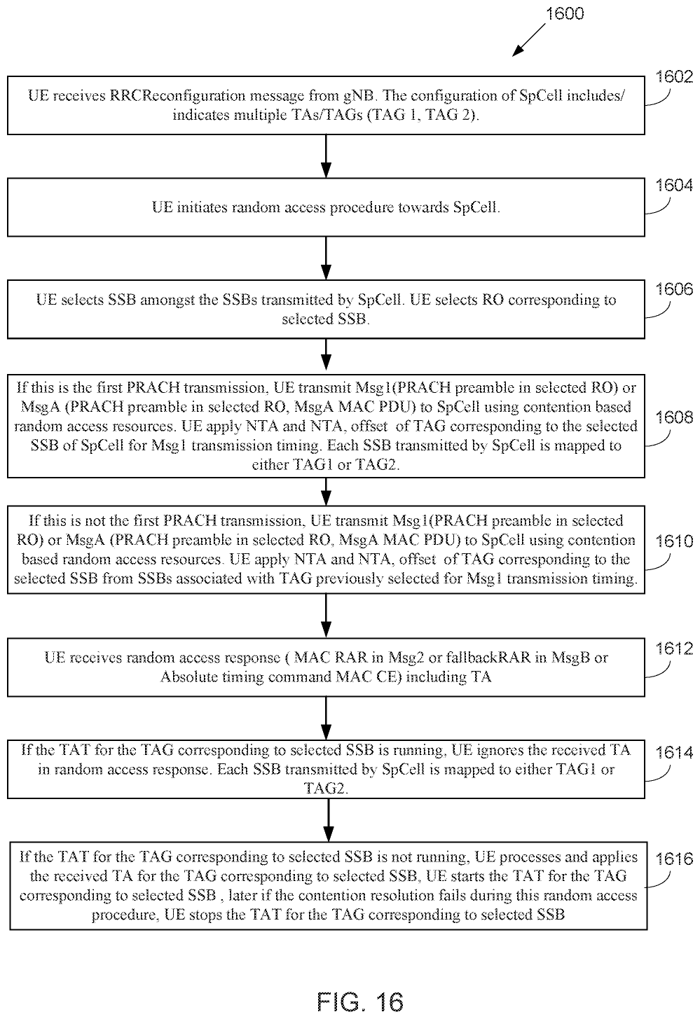

FIG. 16 illustrates a flowchart of a UE method 1600 for initiating RA procedure for multi-TA in intra-/inter-cell beam mobility according to embodiments of the present disclosure. The UE method 1600 as may be performed by a UE (e.g., 111-116 as illustrated in FIG. 1). An embodiment of the UE method 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

As illustrated in FIG. 16, in step 1602, a UE receives an RRCReconfiguration message from gNB. The configuration of SpCell includes/indicates multiple TAs/TAGs (TAG 1, TAG 2). In step 1604, the UE initiates random access procedure towards SpCell. In step 1606, the UE selects SSB amongst the SSBs transmitted by SpCell. The UE selects RO corresponding to selected SSB. In step 1608, if this is the first PRACH transmission, the UE transmits Msg1 (PRACH preamble in selected RO) or MsgA (PRACH preamble in selected RO, MsgA MAC PDU) to SpCell using contention based random access resources, the UE applies NTA and NTA, offset of TAG corresponding to the selected SSB of SpCell for Msg1 transmission timing. Each SSB transmitted by SpCell is mapped to either TAG1 or TAG2. In step 1610, if this is not the first PRACH transmission, the UE transmit Msg1 (PRACH preamble in selected RO) or MsgA (PRACH preamble in selected RO, MsgA MAC PDU) to SpCell using contention based random access resources. The UE applies NTA and NTA, offset of TAG corresponding to the selected SSB from SSBs associated with TAG previously selected for Msg1 transmission timing. In step 1612, the UE receives random access response (MAC RAR in Msg2 or fallbackRAR in MsgB or Absolute timing command MAC CE) including TA. In step 1614, if the TAT for the TAG corresponding to selected SSB is running, the UE ignores the received TA in random access response. Each SSB transmitted by SpCell is mapped to either TAG1 or TAG2. In step 1616, If the TAT for the TAG corresponding to selected SSB is not running, a UE processes and applies the received TA for the TAG corresponding to selected SSB, the UE starts the TAT for the TAG corresponding to selected SSB, later if the contention resolution fails during this random access procedure, the UE stops the TAT for the TAG corresponding to selected SSB.

A UE receives an RRCReconfiguration message from the serving BS/cell. The configuration of SpCell can indicate multiple TAs/TAGs and the related TA parameters for each TA/TAG (e.g., N_TAoffset). For example, 2 TAG IDs can be configured for the SpCell, denoted TAG1 and TAG2. The configuration can indicate the association between the TAGs and SSBs. For example, a SSB index can be linked to a TAG ID.

When RACH is initiated by the UE towards the SpCell (e.g., triggered by scheduling request), the UE selects RA resources. The UE selects SSB amongst the SSBs transmitted by SpCell. The UE selects RO corresponding to selected SSB.

If this is the first PRACH transmission in this triggered RA procedure, the UE selects a SSB (e.g., based on SSB RSRP) from all SSBs transmitted in SpCell. If the selected SSB is associated with TAG1, the UE selects TAG1. The UE applies N_TAoffset corresponding to TAG1 to determine the UL timing for PRACH transmission. If the selected SSB is associated with TAG2, the UE selects TAG2. The UE applies N_TAoffset corresponding to TAG2 to determine the UL timing for PRACH transmission. N_TAoffset with value 0 is applied if N_TAoffset is not configured.

If this is not the first PRACH transmission in this triggered RA procedure, the UE selects a SSB (e.g., based on SSB RSRP) from the SSBs associated with the TAG selected for the previously PRACH transmission. The UE applies the N_TAoffset of the TAG previously selected to the UL timing for PRACH transmission. N_TAoffset with value 0 is applied if N_TAoffset is not configured.

The UE selects RO and preamble corresponding to selected SSB and transmits RA preamble at the selected RO. The UE receives RAR which includes a TA command. If the TAT timer for selected TAG is not running, the UE starts TAT for selected TAG and apply the TA in RAR for selected TAG; else if the TAT timer for the selected TAG is running, the UE ignores the TA in RAR.

In an RACH-less cell level or beam level mobility, the TA is acquired without RACH by NW indication or UE estimation before cell/TRP/beam switch, which may become invalid upon cell/TRP/beam switch and lead to the failure of RACH-less cell/TRP/beam switch. For cell/TRP/beam switch, beam indication can be provided in for cell/beam switch. For example, TCI state or SSB/CSI-RS index can be indicated in cell switch command (e.g., RRCReconfiguration message, MAC CE, PDCCH) for the DL/UL reception/transmission with the target cell. If the indicated beam or RS (e.g., SSB, CSI-RS) or TCI state becomes unsuitable before receiving the confirmation of cell switch completion (e.g., NW acknowledgment for initial UL transmission), RACH-less cell/TRP/beam switch failure happens. The default procedure to handle the failure of cell/TRP/beam switch is to trigger RRC connection reestablishment procedure as specified in 3GPP standard specification. Alternatively, to handle the failure of cell/TRP/beam switch, which may be caused by invalid TA or unsuitable beam indication, a UE can fallback to RACH based switch.

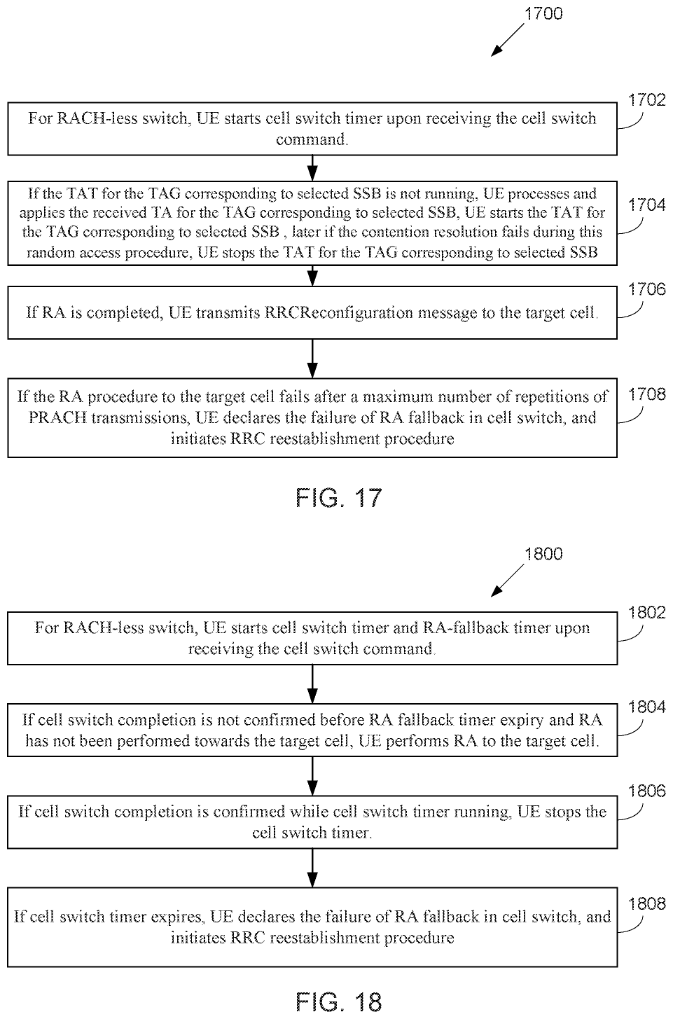

FIG. 17 illustrates a flowchart of a UE method 1700 for a RA fallback procedure in RACH-less mobility according to embodiments of the present disclosure. The method 1700 as may be performed by a UE (e.g., 111-116 as illustrated in FIG. 1). An embodiment of the method 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

As illustrated in FIG. 17, the UE, in step 1702, If the TAT for the TAG corresponding to selected SSB is not running, a UE processes and applies the received TA for the TAG corresponding to selected SSB, the UE starts the TAT for the TAG corresponding to selected SSB, later if the contention resolution fails during this random access procedure, the UE stops the TAT for the TAG corresponding to selected SSB. In step 1704, If the TAT for the TAG corresponding to selected SSB is not running, the UE processes and applies the received TA for the TAG corresponding to selected SSB, the UE starts the TAT for the TAG corresponding to selected SSB, later if the contention resolution fails during this random access procedure, the UE stops the TAT for the TAG corresponding to selected SSB. In step 1706, if RA is completed, the UE transmits an RRCReconfiguration message to the target cell. In step 1708, if the RA procedure to the target cell fails after a maximum number of repetitions of PRACH transmissions, the UE declares the failure of RA fallback in cell switch, and initiates RRC reestablishment procedure.

In one embodiment, as shown in FIG. 17, if the cell/TRP switch is controlled by a switch timer, and RACH-less HO is declared failed as the timer expired, a UE can initiate RACH to the target cell/TRP using the pre-configured RACH configuration for the target cell/TRP. The RA type (e.g., 4-step, 2-step, CBRA, CFRA) can be determined as specified in 3FPP standard specification. For cell switch, a RRCReconfigurationComplete message to the target cell can be included in the MsgA PUSCH payload if 2-step RA is selected or in Msg4 if 4-step RA is selected or in the first PUSCH after RA completion. If the RA procedure to the target cell fails after a maximum number of repetitions of PRACH transmissions, the UE declares the failure of RA fallback in cell switch, and initiates RRC reestablishment procedure.

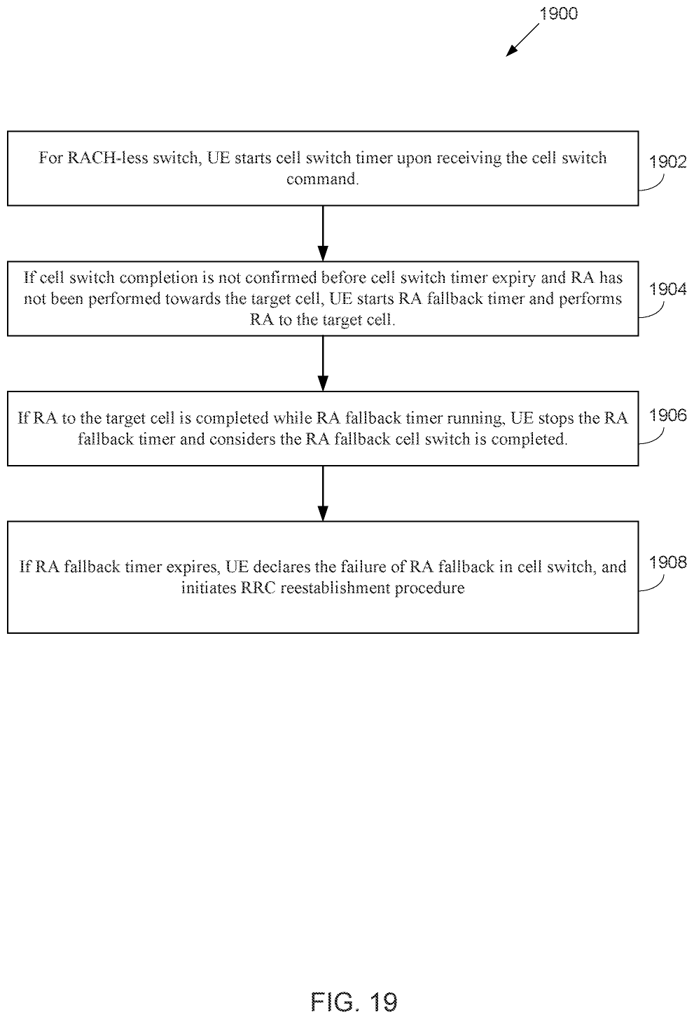

FIGS. 18 and 19 illustrate flowcharts of UE methods 1800 and 1900 for a RA fallback procedure in RACH-less mobility with RA-fallback timer according to embodiments of the present disclosure. The methods 1800 and 1900 as may be performed by a UE (e.g., 111-116 as illustrated in FIG. 1). Embodiments of the method 1800 and 1900 shown in FIGS. 18 and 19 are for illustration only. One or more of the components illustrated in FIGS. 18 and 19 can be implemented in specialized circuitry configured to perform the noted functions or one or more of the components can be implemented by one or more processors executing instructions to perform the noted functions.

As illustrated in FIG. 18, in step 1802, for RACH-less switch, a UE starts cell switch timer and RA-fallback timer upon receiving the cell switch command. In step 1804, if cell switch completion is not confirmed before RA fallback timer expiry and RA has not been performed towards the target cell, the UE performs RA to the target cell. In step 1806, If cell switch completion is confirmed while cell switch timer running, the UE stops the cell switch timer. In step 1808, if cell switch timer expires, the UE declares the failure of RA fallback in cell switch, and initiates RRC reestablishment procedure.

In another embodiment, as shown in FIG. 18, upon initiating RACH-less cell switch to the target cell by applying the target cell configuration, a UE starts a cell switch timer and a RA-fallback timer if configured. The RA-fallback timer for the target cell can be pre-configured with the timer duration indicated. If the UE switches to the target cell successfully (e.g., NW acknowledgment for initial UL transmission is received) while the cell switch timer is running, and if the RA-fallback timer is running, the UE stops the cell switch timer, and stops the RA-fallback timer. If the RA-fallback timer is expired and the cell switch timer is running, and if RA to the target cell was not performed when the cell switch timer was running, the UE initiates RA to the target cell using the RA resource and configuration associated to the target cell. If the RA to the target cell is completed successfully and cell switch completion is confirmed while the cell switch timer is running, the UE stops the cell switch timer. If cell switch completion is not confirmed before cell switch timer is expired, the UE considers cell switch to the target cell is failed, and the UE performs RRC reestablishment or fast recovery for cell switch if configured.

In yet another embodiment, as shown in FIG. 19, upon initiating cell switch to the target cell by applying the target cell configuration, a UE starts a cell switch timer. If the UE switches to the target cell successfully while the cell switch timer is running, the UE stops the cell switch timer. If the cell switch timer is expired, and if RA to the target cell was not performed when the cell switch timer was running, and if a RA-fallback timer is configured, the UE starts the RA-fallback timer, initiates RA to the target cell using the RA resource and configuration associated to the target cell. If the RA to the target cell is completed successfully while the RA-fallback timer is running, the UE considers cell switch to the target cell is completed, stops the RA-fallback timer. If the RA-fallback timer is expired, the UE considers cell switch to the target cell is failed, and the UE performs RRC reestablishment or fast recovery for cell switch if configured.

As illustrated in FIG. 19, in step 1902, for RACH-less switch, a UE starts cell switch timer upon receiving the cell switch command. In step 1904, if cell switch completion is not confirmed before cell switch timer expiry and RA has not been performed towards the target cell, the UE starts RA fallback timer and performs RA to the target cell. In step 1906, if RA to the target cell is completed while RA fallback timer running, the UE stops the RA fallback timer and considers the RA fallback cell switch is completed. In step 1908, if RA fallback timer expires, the UE declares the failure of RA fallback in cell switch, and initiates RRC reestablishment procedure.

In one embodiment, for RACH-less HO procedure, a UE consider the RACH-less HO procedure is on-going when RACH-less HO is configured for the MAC entity by upper layers (e.g., by RRC in RRCReconfiguration message including reconfiguration with sync). As one example is shown in TABLE 3.

TABLE 3
Operations for RACH-less HO

| 1> | when the MAC entity is configured with rach-LessHO: |
|---|---|
| 2> | set the N_{TA} value (as defined in TS 38.211) to the value |
| indicated by targetNTA in rach-LessHO for PTAG; | |
| 2> | start the timeAlignmentTimer associated with PTAG; |

2> consider the RACH-less HO procedure to be ongoing.

In another embodiment, when no SSB for CG (i.e., all CG occasions) has RSRP above the threshold, i.e., when none of the CG occasions is valid, RACH is initiated. For this, a condition for initiating RACH is needed, i.e., “if no SSB configured for RACH-less HO configured grant (e.g., cg-RACH-Less-Configuration) with SS-RSRP above the threshold configured (e.g., RACHless-RSRP-ThresholdSSB) is available, initiate RACH.”

As an example, in TS 38.321, for an uplink grant configured for configured grant Type 1 for RACH-less handover, when there is an on-going RACH-less handover procedure, for each configured uplink grant valid according to TS 38.214 for which the formula for sequential configured uplink grant is satisfied (e.g., as illustrated in TS 38.321), the MAC entity may perform operation as shown in TABLE 4.

TABLE 4
Operations for MAC

| | |
|---|---|
| 1> | if, after the initial transmission of RACH-less handover has been |

performed according to 3GPP standard specification, PDCCH addressed to
the MAC entity's C-RNTI has not been received:

| | |
|---|---|
| 2> | if the SSB corresponding to the configured UL grant has the |

same SSB index as the SSB selected for the initial transmission of
RACH-less handover (i.e., retransmission of initial transmission of
RACH-less handover):

| | |
|---|---|
| 3> | select this SSB; |
| 3> | indicate the SSB index corresponding to the configured uplink |

grant to the lower layer;

| | |
|---|---|
| 3> | consider this configured uplink grant as valid. |
| 1> | else if at least one SSB corresponding to the configured uplink |

grant with SS-RSRP above rach-less-RSRP-ThresholdSSB is available:

| | |
|---|---|
| 2> | select an SSB with SS-RSRP above |

rach-less-RSRP-ThresholdSSB amongst the SSB(s) associated with the
configured uplink grant;

| | |
|---|---|
| 2> | indicate the selected SSB index to the lower layer; |
| 2> | consider this configured uplink grant as valid. |
| 1> | else: |
| 2> | consider this configured uplink grant as not valid; |
| 1> | if no SSB configured for cg-RACH-Less-Configuration with |

SS-RSRP above RACHless-RSRP-ThresholdSSB is available:

| | |
|---|---|
| 2> | initiate random access procedure in 3GPP standard specification |

In one embodiment, for a HARQ feedback transmission in a MAC entity, following operations are provided as shown in TABLE 5.

TABLE 5
HARQ feedback transmission in a MAC entity

```
1> if the timeAlignmentTimer, associated with the TAG containing the Serving Cell on which
the HARQ feedback is to be transmitted, is stopped or expired and if the cg-SDT-
TimeAlignmentTimer, if configured, is not running;
  2> not instruct the physical layer to generate acknowledgement(s) of the data in this TB.
1> else if the HARQ process is configured with disabled HARQ feedback:
  2> if harq-FeedbackEnablingforSPSactive is configured with enabled and the transmission
is the first transmission after activation of the configured downlink assignment:
    3> instruct the physical layer to generate acknowledgement(s) of the data in this TB.
  2> else:
    3> not instruct the physical layer to generate acknowledgement(s) of the data in this
TB.
1> else:
  2> instruct the physical layer to generate acknowledgement(s) of the data in this TB.
```

In case one or multiple TAGs are configured for a serving cell, in one embodiment, the MAC entity may perform following operations as shown in TABLE 6.

TABLE 6
HARQ feedback transmission in a MAC entity

```
1> if the timeAlignmentTimer, associated with all TAG(s) associated/configured to the Serving
Cell on which the HARQ feedback is to be transmitted, is stopped or expired and if the cg-SDT-
TimeAlignmentTimer, if configured, is not running;
  2> not instruct the physical layer to generate acknowledgement(s) of the data in this TB.
1> else if the HARQ process is configured with disabled HARQ feedback:
  2> if harq-FeedbackEnablingforSPSactive is configured with enabled and the transmission
is the first transmission after activation of the configured downlink assignment:
    3> instruct the physical layer to generate acknowledgement(s) of the data in this TB.
  2> else:
    3> not instruct the physical layer to generate acknowledgement(s) of the data in this
TB.
1> else:
  2> instruct the physical layer to generate acknowledgement(s) of the data in this TB.
```

In another embodiment, if the timeAlignmentTimer, associated with any one TAG associated/configured to the serving cell on which the HARQ feedback is to be transmitted, is stopped or expired and if the cg-SDT-TimeAlignmentTimer, if configured, is not running, the MAC entity may not instruct the physical layer to generate acknowledgement(s) of the data in this TB using TCI state(s) associated to this TAG.

For the case that TAGs are configured, if the TAT of one TAG is expired, then for all serving cells configured with this TAG and a second TAG for which the timeAlignmentTimer is running, the HARQ buffer may or may not be flushed.

In one example, the HARQ buffer is flushed for the HARQ process that is associated with this TAG (e.g., for the HARQ process for which the TA associated to this TAG is applied).

In another example, if a UE is configured to flush HARQ buffer for the operation of multi-DCI multi-TRP with 2 TAs, the HARQ buffer is flushed for the HARQ process that is associated with this TAG (e.g., for the HARQ process for which the TA associated to this TAG is applied). An RRC parameter (e.g., flushHARQfor2TA) can be defined for the operation of multi-DCI multi-TRP with 2 TAs. If the parameter is enabled, UE is configured to flush HARQ buffer for the operation of multi-DCI multi-TRP with 2 TAs in the case described above; otherwise (e.g., not enabled or absent), UE is NOT configured to flush HARQ buffer for the operation of multi-DCI multi-TRP with 2 TAs.

In yet another example, if a UE is not capable of supportRetx-Diff-CoresetPool-Multi-DCI-TRP as specified in TS 38.306, the HARQ buffer is flushed for the HARQ process that is associated with this TAG (e.g., for the HARQ process for which the TA associated to this TAG is applied).

For the absolute TAC MAC CE, a TAG indication can be included. In one example, if 2 TAGs are configured for a serving cell (e.g., SpCell), a reserved bit in absolute TAC MAC CE can be used for TAG indication, i.e., the bit set to 0 indicates the first TAG for the serving cell (e.g., SpCell) and the bit set to 1 indicates the second TAG for the serving cell (e.g., SpCell). If only one TAG is configured for a serving cell (e.g., SpCell), the reserved bit is present.

In another example, a TAG ID can be included in the absolute TAC MAC CE. If 2 TAGs are configured for a serving cell (e.g., SpCell), 2 reserved bits are used to indicate the TAG ID. If only one TAG is configured for a serving cell (e.g., SpCell), the reserved bits are present.

In another example, an RRC parameter is defined to enable TAG indication in absolute TAC MAC CE. If the parameter is enabled/present, TAG indication is enabled in the absolute TAC MAC CE for multi-DCI multi-TRP with 2 TAs; otherwise (i.e., the parameter is absent), TAG indication is not enabled in the absolute TAC MAC CE. If TAG indication in absolute TAC MAC CE is enabled, a reserved bit in absolute TAC MAC CE can be used for TAG indication, i.e., the bit set to 0 indicates the first TAG for the serving cell (e.g., SpCell) and the bit set to 1 indicates the second TAG for the serving cell (e.g., SpCell). If TAG indication in absolute TAC MAC CE is NOT enabled, the reserved bit is present.

In yet another example, an RRC parameter is defined to enable TAG ID in absolute TAC MAC CE. If the parameter is enabled/present, TAG ID is enabled in the absolute TAC MAC CE for multi-DCI multi-TRP with 2 TAs; otherwise (i.e., the parameter is absent), TAG ID is not enabled in the absolute TAC MAC CE. If TAG ID in absolute TAC MAC CE is enabled, 2 reserved bits in absolute TAC MAC CE can be used for TAG ID. If TAG ID in absolute TAC MAC CE is NOT enabled, the reserved bits are present.

If the TAG indication/ID is not included in the absolute TAC MAC CE, and if 2 TAGS are applied for the serving cell (e.g., SpCell), UE applies the TA in the absolute MAC CE to the first TAG of the serving cell (e.g., SpCell), or to the TAG with ID 0 of the MAC entity.

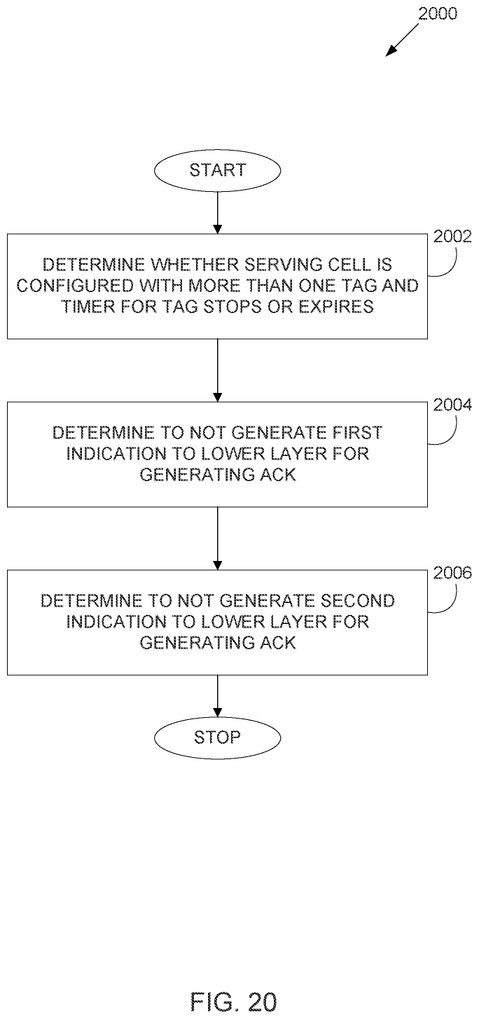

FIG. 20 illustrates a flowchart of a UE method 2000 for multiple timing advance groups for a multi-TRP wireless communication system according to embodiments of the present disclosure. The method 2000 as may be performed by a UE (e.g., 111-116 as illustrated in FIG. 1). An embodiment of the method 2000 shown in FIG. 20 is for illustration only. One or more of the components illustrated in FIG. 20 can be implemented in specialized circuitry configured to perform the noted functions or one or more of the components can be implemented by one or more processors executing instructions to perform the noted functions.

As illustrated in FIG. 20, the method 2000 begins at step 2002. In step 2002, the UE determines whether a serving cell is configured with more than one TAG and a timer of a TAG associated with a TCI state stops or expires for (i) a transmission of a first HARQ feedback in a first HARQ process on the serving cell or (ii) a transmission of a second HARQ feedback in a second HARQ process on the serving cell.

In step 2004, the UE determines, based on a determination that the serving cell is configured with more than one TAG and the timer of the TAG associated with the TCI state for the transmission of the first HARQ feedback is stopped or expired, to not generate a first indication indicating a lower layer to generate an ACK corresponding to a data transmission in a TB in the first HARQ process.

In step 2006, the UE determines, based on a determination that the serving cell is configured with more than one TAG and the timer of the TAG associated with the TCI state for the transmission of the second HARQ feedback is stopped or expired, to not generate a second indication indicating the lower layer to generate an ACK corresponding to a data transmission in a TB in the second HARQ process when the serving cell is configured with a sl-PUCCH-Config.

In one embodiment, the UE receives, from a BS, an absolute TAC MAC CE, determines whether more than one TAG is configured for a SpCell, identifies, based on a determination that more than one TAG is configured for the SpCell, a TAG indication setting to zero in the absolute TAC MAC CE indicating a first TAG ID for the SpCell and the TAG indication setting to one indicating a second TAG ID for the SpCell, applies a TAC included in the absolute TAC MAC CE to a TAG for the SpCell based on the first TAG ID or the second TAG ID, and starts a timer (timeAlignmentTimer) associated with the TAG.

In one embodiment, when a first timer (timeAlignmentTimer) associated with a first TAG identified by the first TAG ID expires and a second timer (timeAlignmentTimer) associated with a second TAG identified by the second TAG ID expires for a serving cell configured with the first TAG and the second TAG, the UE flushes HARQ buffers, indicates a RRC layer to release a PUCCH, indicates the RRC layer to release a SRS; disables downlink assignment and uplink grants that are configured, disables PUSCH resources for a semi-persistent CSI reporting, and maintains a TA between a downlink and an uplink (NTA) of the first TAG.

In one embodiment, when a first timer (timeAlignmentTimer) associated with a first TAG identified by the first TAG ID expires and a second timer (timeAlignmentTimer) associated with a second TAG identified by the second TAG ID is running for a serving cell configured with the first TAG and the second TAG, the UE disables downlink assignment and uplink grants that are configured only with TCI states associated with the first TAG, disables, for a semi-persistent CSI reporting, PUSCH resources that are configured only with TCI states associated with the first TAG, and maintains a TA between a downlink and an uplink (NTA) of the first TAG.

In one embodiment, the UE receives, from a BS, a MAC RAR or a fallback RAR, determines whether more than one TAG is configured for a serving cell where a RAR applies, and identifies, based on a determination that more than one TAG is configured for the serving cell, an indication setting to zero in a corresponding RAR indicating a first TAG ID for the serving cell and the indication setting to one indicating a second TAG ID for the serving cell.

In one embodiment, the UE receives, in response to transmitting a random access preamble, a TAC in a RAR message or a MsgB, the RAR message or the MsgB including a TAG indication, and applies the TAC to the TAG and start or restart a timer (timeAlignmentTimer) associated with the TAG when the random access preamble is not selected among contention-based random access preambles, or applies the TAC to the TAG and start the timer associated with the TAG when the timer associated with the TAG is not running.

In one embodiment, the UE indicates, by a MAC entity, a RRC layer to release an SRS for serving cells when more than one TAG is configured with a SpCell and timers (timeAlignmentTimers) associated with entire PTAGs expire.

In one embodiment, the UE determines not to perform UL transmissions except a random access preamble and a msgA on a serving cell using a TCI state associated with the TAG for which the timer is not running and determines not to perform UL transmissions on entire serving cells except the random access preamble and the msgA on the SpCell when more than one PTAG is configured with the SpCell and the timers associated with entire PTAGs are not running.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver; and
a processor operably coupled to the transceiver, the processor configured to:
determine whether a serving cell is configured with more than one timing advance group (TAG) and a timer of a TAG associated with a transmission configuration indication (TCI) state stops or expires for (i) a transmission of a first hybrid automatic repeat request (HARQ) feedback in a first HARQ process on the serving cell or (ii) a transmission of a second HARQ feedback in a second HARQ process on the serving,
determine, based on a determination that the serving cell is configured with more than one TAG and the timer of the TAG associated with the TCI state for the transmission of the first HARQ feedback is stopped or expired, to not generate a first indication indicating a lower layer to generate an acknowledgement (ACK) corresponding to a data transmission in a transport block (TB) in the first HARQ process, and
determine, based on a determination that the serving cell is configured with more than one TAG and the timer of the TAG associated with the TCI state for the transmission of the second HARQ feedback is stopped or expired, to not generate a second indication indicating the lower layer to generate an ACK corresponding to a data transmission in a TB in the second HARQ process when the serving cell is configured with a sidelink physical uplink control channel configuration (sl-PUCCH-Config).

2. The UE of claim 1, wherein:
the transceiver is configured to receive, from a base station (BS), an absolute timing advance command medium access control control element (TAC MAC CE); and
the processor is further configured to:
determine whether more than one TAG is configured for a special cell (SpCell),
identify, based on a determination that more than one TAG is configured for the SpCell, a TAG indication setting to zero in the absolute TAC MAC CE indicating a first TAG identifier (ID) for the SpCell and the TAG indication setting to one indicating a second TAG ID for the SpCell,
apply a TAC included in the absolute TAC MAC CE to a TAG for the SpCell based on the first TAG ID or the second TAG ID, and
start a timer (timeAlignmentTimer) associated with the TAG.

3. The UE of claim 2, wherein, when a first timer (timeAlignmentTimer) associated with a first TAG identified by the first TAG ID expires and a second timer (timeAlignmentTimer) associated with a second TAG identified by the second TAG ID expires for a serving cell configured with the first TAG and the second TAG, the processor is further configured to, for the serving cell:
flush hybrid automatic repeat request (HARQ) buffers;
indicate a radio resource control (RRC) layer to release a physical uplink control channel (PUCCH);
indicate the RRC layer to release a sounding reference signal (SRS);
disable downlink assignment and uplink grants that are configured;
disable physical uplink shared channel (PUSCH) resources for a semi-persistent channel state information (CSI) reporting; and
maintain a timing advance (TA) between a downlink and an uplink (N_{TA}) of the first TAG.

4. The UE of claim 2, wherein, when a first timer (timeAlignmentTimer) associated with a first TAG identified by the first TAG ID expires and a second timer (timeAlignmentTimer) associated with a second TAG identified by the second TAG ID is running for a serving cell configured with the first TAG and the second TAG, the processor is further configured to, for the serving cell:
disable downlink assignment and uplink grants that are configured only with TCI states associated with the first TAG;
disable, for a semi-persistent channel state information (CSI) reporting, physical uplink shared channel (PUSCH) resources that are configured only with TCI states associated with the first TAG; and
maintain a timing advance (TA) between a downlink and an uplink (N_{TA}) of the first TAG.

5. The UE of claim 1, wherein:
the transceiver is configured to receive, from a base station (BS), a MAC random access response (MAC RAR) or a fallback RAR; and
the processor is further configured to:
determine whether more than one TAG is configured for a serving cell where a random access response (RAR) applies, and
identify, based on a determination that more than one TAG is configured for the serving cell, a TAG indication setting to zero in a corresponding RAR indicating a first TAG identifier (ID) for the serving cell and the TAG indication setting to one indicating a second TAG ID for the serving cell.

6. The UE of claim 1, wherein:
the transceiver is configured to receive, in response to transmitting a random access preamble, a TAC in a random access response (RAR) message or a message B (MsgB), the RAR message or the MsgB including a TAG indication; and
the processor is further configured to:
apply the TAC to the TAG and start or restart a timer (timeAlignmentTimer) associated with the TAG when the random access preamble is not selected among contention-based random access preambles, or
apply the TAC to the TAG and start the timer associated with the TAG when the timer associated with the TAG is not running.

7. The UE of claim 1, wherein the processor is further configured to indicate, by a medium access control (MAC) entity, a radio resource control (RRC) layer to release a sounding reference signal (SRS) for serving cells when more than one TAG is configured with a special cell (SpCell) and timers (timeAlignmentTimers) associated with entire primary TAGs (PTAGs) expire.

8. The UE of claim 7, wherein the processor is further configured to:
determine not to perform UL transmissions except a random access preamble and a message A (msgA) on a serving cell using a TCI state associated with the TAG for which the timer is not running; and
determine not to perform UL transmissions on entire serving cells except the random access preamble and the msgA on the SpCell when more than one PTAG is configured with the SpCell and the timers associated with entire PTAGs are not running.

9. A method of a user equipment (UE) in a wireless communication system, the method comprising:
determining whether a serving cell is configured with more than one timing advance group (TAG) and a timer of a TAG associated with a transmission configuration indication (TCI) state stops or expires for (i) a transmission of a first hybrid automatic repeat request (HARQ) feedback in a first HARQ process on the serving cell or (ii) a transmission of a second HARQ feedback in a second HARQ process on the serving cell;
determining, based on a determination that the serving cell is configured with more than one TAG and the timer of the TAG associated with the TCI state for the transmission of the first HARQ feedback is stopped or expired, to not generate a first indication indicating a lower layer to generate an acknowledgement (ACK) corresponding to a data transmission in a transport block (TB) in the first HARQ process; and
determining, based on a determination that the serving cell is configured with more than one TAG and the timer of the TAG associated with the TCI state for the transmission of the second HARQ feedback is stopped or expired, to not generate a second indication indicating the lower layer to generate an ACK corresponding to a data transmission in a TB in the second HARQ process when the serving cell is configured with a sidelink physical uplink control channel configuration (sl-PUCCH-Config).

10. The method of claim 9, further comprising:
receiving, from a base station (BS), an absolute timing advance command medium access control control element (TAC MAC CE);
determining whether more than one TAG is configured for a special cell (SpCell);
identifying, based on a determination that more than one TAG is configured for the SpCell, a TAG indication setting to zero in the absolute TAC MAC CE indicating a first TAG identifier (ID) for the SpCell and the TAG indication setting to one indicating a second TAG ID for the SpCell;
applying a TAC included in the absolute TAC MAC CE to a TAG for the SpCell based on the first TAG ID or the second TAG ID; and
starting a timer (timeAlignmentTimer) associated with the TAG.

11. The method of claim 10, wherein, when a first timer (timeAlignmentTimer) associated with a first TAG identified by the first TAG ID expires and a second timer (timeAlignmentTimer) associated with a second TAG identified by the second TAG ID expires for a serving cell configured with the first TAG and the second TAG, further comprising, for the serving cell:
flushing hybrid automatic repeat request (HARQ) buffers;
indicating a radio resource control (RRC) layer to release a physical uplink control channel (PUCCH);
indicating the RRC layer to release a sounding reference signal (SRS);
disabling downlink assignment and uplink grants that are configured;
disabling physical uplink shared channel (PUSCH) resources for a semi-persistent channel state information (CSI) reporting; and
maintaining a timing advance (TA) between a downlink and an uplink (N_{TA}) of the first TAG.

12. The method of claim 10, wherein, when a first timer (timeAlignmentTimer) associated with a first TAG identified by the first TAG ID expires and a second timer (timeAlignmentTimer) associated with a second TAG identified by the second TAG ID is running for a serving cell configured with the first TAG and the second TAG, further comprising, for the serving cell:
disabling downlink assignment and uplink grants that are configured only with TCI states associated with the first TAG;
disabling, for a semi-persistent channel state information (CSI) reporting, physical uplink shared channel (PUSCH) resources that are configured only with TCI states associated with the first TAG; and
maintaining a timing advance (TA) between a downlink and an uplink (N_{TA}) of the first TAG.

13. The method of claim 9, further comprising:
receiving, from a base station (BS), a MAC random access response (MAC RAR) or a fallback RAR;
determining whether more than one TAG is configured for a serving cell where a random access response (RAR) applies; and
identifying, based on a determination that more than one TAG is configured for the serving cell, a TAG indication setting to zero in a corresponding RAR indicating a first TAG identifier (ID) for the serving cell and the TAG indication setting to one indicating a second TAG ID for the serving cell.

14. The method of claim 9, further comprising:
receiving, in response to transmitting a random access preamble, a TAC in a random access response (RAR) message or a message B (MsgB), the RAR message or the MsgB including a TAG indication; and
applying the TAC to the TAG and start or restart a timer (timeAlignmentTimer) associated with the TAG when the random access preamble is not selected among contention-based random access preambles; or
applying the TAC to the TAG and start the timer associated with the TAG when the timer associated with the TAG is not running.

15. The method of claim 9, further comprising indicating, by a medium access control (MAC) entity, a radio resource control (RRC) layer to release a sounding reference signal (SRS) for serving cells when more than one TAG is configured with a special cell (SpCell) and timers (timeAlignmentTimers) associated with entire primary TAGs (PTAGs) expire.

16. The method of claim 15, further comprising:
determining not to perform UL transmissions except a random access preamble and a message A (msgA) on a serving cell using a TCI state associated with the TAG for which the timer is not running; and
determining not to perform UL transmissions on entire serving cells except the random access preamble and the msgA on the SpCell when more than one PTAG is configured with the SpCell and the timers associated with entire PTAGs are not running.

17. A base station (BS) in a wireless communication system, the BS comprising:
a processor; and
a transceiver operably coupled to the processor, the transceiver configured to receive, from a user equipment (UE), a transmission of a first hybrid automatic repeat request (HARQ) feedback in a first HARQ process or a transmission of a second HARQ feedback in a second HARQ process, the BS belonging to a serving cell,
wherein:
whether the serving cell is configured with more than one TAG and a timer of a TAG associated with a TCI state stops or expires for (i) the transmission of a first HARQ feedback in the first HARQ process on the serving cell is determined or (ii) the transmission of the second HARQ feedback in a second HARQ process on the serving cell is determined,
based on a determination that the serving cell is configured with more than one TAG and the timer of the TAG associated with the TCI state for the transmission of the first HARQ feedback is stopped or expired, an acknowledgement (ACK) corresponding to a data transmission in a transport block (TB) in the first HARQ process is not received, and
based on a determination that the serving cell is configured with more than one TAG and the timer of the TAG associated with the TCI state for the transmission of the second HARQ feedback is stopped or expired, an ACK corresponding to a data transmission in a TB in the second HARQ process is not received when the serving cell is configured with a sidelink physical uplink control channel configuration (sl-PUCCH-Config).

18. The BS of claim 17, wherein the transceiver is further configured to transmit, to the UE, an absolute timing advance command medium access control control element (TAC MAC CE) including a TAG indication based on a determination that more than one TAG is configured for the SpCell, and wherein the TAG indication setting to zero in the absolute TAC MAC CE indicates a first TAG identifier (ID) for the SpCell and the TAG indication setting to one indicates a second TAG ID for the SpCell.

19. The BS of claim 17, wherein the transceiver is further configured to transmit, to the UE, a MAC random access response (MAC RAR) or a fallback RAR including a TAG indication based on a determination that more than one TAG is configured for a serving cell where a random access response (RAR) applies, and wherein the TAG indication setting to zero in a corresponding RAR indicates a first TAG identifier (ID) for the serving cell and the TAG indication setting to one indicates a second TAG ID for the serving cell.

20. The BS of claim 17, wherein the transceiver is further configured to transmit, in response to receiving a random access preamble, a TAC in a random access response (RAR) message or a message B (MsgB), the RAR message or the MsgB including a TAG indication.
